(19) United States
(12) Patent Application Publication
(10) Pub. No.: US 2026/0342826 A1
(43) Pub. Date: Oct. 29, 2026

(54) Enhanced Proactive Threat Detection and Secure Data Management System

(71) Applicant: Bank of America Corporation, Charlotte, NC (US)

(72) Inventor: Govind Buddha, Wilmington, DE (US)

(73) Assignee: Bank of America Corporation, Charlotte, NC (US)

(21) Appl. No.: 19/188,975

(22) Filed: Apr. 24, 2025

(51) Int. Cl. H04L 9/40

(52) U.S. Cl. CPC H04L 63/1425

(57) ABSTRACT

Various aspects of the disclosure relate to automated monitoring of data access events and identifying anomalous data access activities, particularly for sensitive or non-public information. A data access monitoring and security system integrates blockchain technology for logging actions related to accessing and/or copying sensitive user information by utilize AI algorithms to analyze identified data access events real-time to detect abnormal behaviour. If such activity is identified, the system generates a remedial action. A blockchain ledger records every instance of a data access event and an activity monitor detects abnormal behaviours. A smart contract module enforces a predefined rule set that may automatically trigger alerts and/or block actions of users upon identification of unauthorized copying.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information with external computer systems in providing and/or supporting different products and services offered by the organization. For example, presently available digital platforms process sensitive user information such as government issued identification numbers, important or otherwise personally identifying dates, credit card numbers, and/or the like. Such private, secure, or otherwise secret information is often at risk of unauthorized copying, theft, and/or improper use. Existing solutions seeking to provide data security focus on securing the data, but fail to adequately monitor any actual use of the sensitive data, such as copying, extraction, or other dissemination events. As such, fraudulent access and/or copying of this sensitive data can lead to identity theft, financial loss, and data breaches.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes integrating blockchain functionality and artificial intelligence (AI)-based analysis of data access events throughout an enterprise network to identify suspect instances of data copying, access, and/or dissemination. Aspects of the disclosure relate to computer hardware and software. In particular, one or more aspects of the disclosure generally relate to computer hardware and software for monitoring data access events throughout an enterprise network to detect instances of suspicious behavior including unauthorized copying or excessive extraction of sensitive information.

The data access monitoring and security system integrates blockchain technology for logging actions related to accessing and/or copying sensitive user information, such as identification numbers, important dates, and credit card numbers, and/or the like. The system and methods utilize AI algorithms that analyze identified data access events and/or actions in real-time to detect abnormal behaviour, such as the unauthorized copying of sensitive data. If such activity is identified, the system generates a remedial action such as, for example, triggering of an alert or automatically initiating corrective actions to prevent further unauthorized access. The data access monitoring and security system utilizes a blockchain ledger to securely record every instance of a data access event (e.g., copying sensitive user information). The system further includes an AI-based activity monitor to analyze the logged data access activities (e.g. user activities, automated bot activities, and/or other activities involving data access) to detect abnormal or otherwise suspicious behaviours, including excessive copying of sensitive information. A smart contract module may be used to enforce a predefined rule set that may automatically trigger alerts and/or block actions of users upon identification of unauthorized copying. The data access monitoring and security system further may incorporate one or more data copy detection algorithm to identify and/or flag unauthorized copying attempts based on matching of an identified activity patter to pre-defined patterns and/or irregular user activities.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative example of centralized computer system in accordance with one or more aspects described herein;

FIG. 2 shows an illustrative example of decentralized peer-to-peer (P2P) computer system that may be used in accordance with one or more aspects described herein;

FIG. 3A shows an illustrative example of a full node computing device that may be used in accordance with one or more aspects described herein;

FIG. 3B shows an illustrative example of a lightweight node computing device that may be used in accordance with one or more aspects described herein;

FIG. 4 shows an illustrative example of a suitable computing system environment that may be used in accordance with one or more aspects described herein;

FIG. 5A shows an illustrative computing environment for implementing a data copying and monitoring system, in accordance with one or more aspects described herein;

FIG. 5B shows an illustrative computing platform enabled for identifying, monitoring, analyzing, and responding to data copying events in a computing environment, in accordance with one or more aspects described herein; and

FIG. 6 shows an illustrative data access monitoring and security system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

The data access monitoring and security system may provide real-time detection and/or prevention of improper use of data utilized within an enterprise network. While many current systems may focus on post-incident analysis of data misuse events, the data access monitoring and security system may utilize AI to flag and prevent unauthorized access and/or copying in real-time, thus a risk of data breaches. The data access monitoring and security system, as a decentralized system, also provides enhanced traceability of data use throughout the enterprise network and a method of verifying accountability for all data access performed within the network. This may be facilitated through use of blockchain systems that can provide a transparent and detailed audit trail of accounts and/or applications that accessed any sensitive data. Further, the data access monitoring and security system may address modern threat vectors as they evolve by utilizing the blockchain and intelligent algorithms that may identify and/or evolve to adjust to security threats and/or network vulnerabilities, such as insider attacks, sophisticated phishing attacks, lateral movement events, and/or the like.

The data access monitoring and security system may utilize a blockchain ledger, an activity monitoring system, one or more data copy detection algorithms, an inactivity detection algorithm, and/or a smart contract mechanism. The blockchain ledger securely records data access events including all instances of data access comprising copying of sensitive user information, including user identification numbers, important dates associated with users, and credit card details, and/or the like. Each data access event (e.g., a copy action, a read action, a send action, and the like) is timestamped and stored as a block in the blockchain, providing an immutable record that cannot be changed. The activity monitoring system may be AI-based and may continuously monitor user activities, such as those related to copying sensitive data. The data access monitoring and security system uses historical activity data to establish a baseline for each user account and flags any deviations from normal behavior. For example, copying multiple user identification numbers or credit card numbers within a short time frame triggers an alert.

The data access monitoring and security system includes one or more copy detection algorithms to detect if a user is copying sensitive information in an unauthorized manner. For example, an illustrative copy detection and/or data movement detection algorithm may compare the data being copied with predefined patterns, such as known valid personal identification numbers, user date information, and/or credit card formats. If the data being copied does not match the expected patterns or exceeds defined thresholds, the data access monitoring and security system flags that event (or events) as suspicious.

The data access monitoring and security system includes an inactivity detection engine that allows monitoring of periods of inactivity for each user account, which can be indicative of unauthorized access. For example, if a user fails to perform any actions for a specified period but still attempts to copy sensitive data, the data access events would be flagged as suspicious behaviour.

A smart contract mechanism of the data access monitoring and security system may manage smart contracts utilized by the system. A smart contract may be used to automatically respond to detected violations. For example, if the data access monitoring and security system detects unauthorized copying of user identification numbers or credit card details, the smart contract can lock the user's account and alert the administrators. Additionally, if an abnormal pattern of data copying is detected, the smart contract could require re-authentication or apply additional security checks.

Illustrative examples describing various scenarios of operation of the data access monitoring and security system may include a first scenario of unauthorized copying of sensitive information (e.g., personal identification information). For example, a user attempts to copy an identification number from the system. The monitoring system detects data access event, and the data access monitoring and security system identifies that the identification number being copied does not match the expected pattern (e.g., it's a random string or has an invalid format). The data access monitoring and security system flags the activity as suspicious and triggers an alert. The smart contract locks the user's account to prevent further access, and an alert is sent to the system administrator for investigation. In a second example scenario of excessive copying of data, a user repeatedly copies multiple credit card details in a short amount of time. The data access monitoring and security system detects the excessive copying behavior and triggers an alert. The smart contract is executed, which locks the user's access until further investigation or requires the user to undergo additional verification steps.

As mentioned above, a distributed ledger computing system (e.g., a blockchain system, a Holochain system, and the like) is a peer-to-peer, distributed data repository that provides an immutable record of information. The disclosure provided herein is described, at least in part, in relation to a decentralized peer-to-peer (e.g., P2P) system specialized for the purpose of managing a blockchain. The decentralized P2P system may be comprised of computing devices that are distributed in multiple locations across a geographical area as opposed to a single location. The computing devices forming the decentralized P2P system may operate with each other to manage a blockchain, which may be a data structure used to store information related to the decentralized P2P system. More specifically, the blockchain may be a chronological linkage of data elements (e.g., blocks) which store data records relating to the decentralized computing system.

A user may access the decentralized P2P system through a specialized “wallet” that serves to uniquely identify the user and enable the user to perform functions related to the decentralized P2P network. Through the wallet, the user may be able to hold tokens, funds, and/or any other asset associated with the decentralized P2P system. Furthermore, the user may be able to use the wallet to request performance of network-specific functions related to the decentralized P2P system such as fund, token, and/or asset transfers. The various computing devices forming the decentralized P2P computing system may operate as a team to perform network-specific functions requested by the user. In performing the network-specific functions, the various computing devices may produce blocks that store the data generated during the performance of the network-specific functions and may add the blocks to the blockchain. After the block has been added to the blockchain, the wallet associated with the user may indicate that the requested network-specific function has been performed.

For example, a user may have a wallet which reflects that the user has five tokens associated with the decentralized P2P system. The user may provide a request to the decentralized P2P system to transfer the five tokens to a friend who also has a wallet. The various computing devices forming the decentralized P2P computing system may perform the request and transfer the five tokens from the wallet of the user to the wallet of the friend. In doing so, a block may be created by the various computing devices of the decentralized P2P computing system. The block may store data indicating that the five tokens were transferred from the wallet of the user to the wallet of the friend. The various computing devices may add the block to the blockchain. At such a point, the wallet of the user may reflect the transfer of the five tokens to the wallet of the friend, and may indicate a balance of zero. The wallet of the friend, however, may also reflect the transfer of the five tokens and may have a balance of five tokens.

In more detail, the decentralized P2P system may be specialized for the purpose of managing a distributed ledger, such as a private blockchain or a public blockchain, through the implementation of digital cryptographic hash functions, consensus algorithms, digital signature information, and network-specific protocols and commands. The decentralized P2P system (e.g., decentralized system) may be comprised of decentralized system infrastructure consisting of a plurality computing devices, either of a heterogeneous or homogenous type, which serve as network nodes (e.g., full nodes and/or lightweight nodes) to create and sustain a decentralized P2P network (e.g., decentralized network). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions of the decentralized network, such as balance sheet transactions and smart contract operations, at least a portion of the full nodes forming the decentralized network may execute the one or more cryptographic hash functions, consensus algorithms, and network-specific protocols to register a requested network function on the blockchain. In some instances, a plurality of network function requests may be broadcasted across at least a portion of the full nodes of the decentralized network and aggregated through execution of the one or more digital cryptographic hash functions and by performance of the one or more consensus algorithms to generate a single work unit (e.g., block), which may be added in a time-based, chronological manner to the blockchain through performance of network-specific protocols.

While in practice the term “blockchain” may hold a variety of contextually derived meanings, the term blockchain, as used herein, refers to a concatenation of sequentially dependent data elements (e.g., blocks) acting as a data ledger that stores records relating to a decentralized computing system. Such data records may be related to those used by a particular entity or enterprise, such as a financial institution, and/or may be associated with a particular application and/or use case including, but not limited to, cryptocurrency, digital content storage and delivery, entity authentication and authorization, digital identity, marketplace creation and operation, internet of things (e.g., IoT), prediction platforms, balloting, well-being records, currency exchange and remittance, P2P transfers, ride sharing, participatory electronic entertainment, trading platforms, and real estate, precious metal, and work of art registration and transference, among others. A “private blockchain” may refer to a blockchain of a decentralized private system in which only authorized computing devices are permitted to act as nodes in a decentralized private network and have access to the private blockchain. In some instances, the private blockchain may be viewable and/or accessible by authorized computing devices which are not participating as nodes within the decentralized private network, but still have proper credentials. A “public blockchain” may refer to a blockchain of a decentralized public system in which any computing devices may be permitted to act as nodes in a decentralized public network and have access to the public blockchain. In some instances, the public blockchain may be viewable and/or accessible by computing devices which are not participating as nodes within the decentralized public network.

Further, a “full node” or “full node computing device,” as used herein, may describe a computing device in a decentralized system which operates to create and maintain a decentralized network, execute requested network functions, and maintain inter-nodal agreement as to the state of the blockchain. In order to perform such responsibilities, a computing device operating as a full node in the decentralized system may have a complete replica or copy of the blockchain stored in memory, as well as executable instructions for the execution of hash functions, consensus algorithms, digital signature information, network protocols, and network commands. A “lightweight node,” “light node,” “lightweight node computing device,” or “light node computing device” may refer to a computing device in a decentralized system, which operates to request performance of network functions (e.g., balance sheet transactions, smart contract operations, and the like) within a decentralized network but without the capacity to execute requested network functions and maintain inter-nodal agreement as to the state of the blockchain. As such, a computing device operating as a lightweight node in the decentralized system may have a partial replica or copy of the blockchain. In some instances, network functions requested by lightweight nodes to be performed by the decentralized network may also be able to be requested by full nodes in the decentralized system.

“Network functions” and/or “network-specific functions,” as described herein, may relate to functions which are able to be performed by nodes of a decentralized P2P network. In some arrangements, the data generated in performing network-specific functions may or may not be stored on a blockchain associated with the decentralized P2P network. Examples of network functions may include “smart contract operations.” A smart contract operation, as used herein, may describe one or more operations performed by a “smart contract,” which may be one or more algorithms and/or programs associated with one or more nodes within a decentralized P2P network. For example, the one or more algorithms and/or programs may correspond to addition of a NFT-API to a blockchain or querying of NFT-APIs stored in a blockchain. Addition of NFT-APIs may correspond to updating those stored in the blockchain.

In one or more aspects of the disclosure, a “digital cryptographic hash function,” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPoS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network. A wallet may be associated with a public key, which may serve to identify the wallet. In requesting performance of network operations, a private key associated with the wallet may be used to digitally sign the network operation requests.

As will be described in further detail below, a decentralized P2P system implementing a blockchain data structure may provide solutions to technological problems existing in current centralized system constructs with traditional data storage arrangements. For example, conventional data storage arrangements that use a central data authority have a single point of failure (namely, the central storage location) which, if compromised by a malicious attacker, can lead to data tampering, unauthorized data disclosure, and illicit use and/or loss of operative control of the processes performed by the centralized system. The implementation of a blockchain data structure in a decentralized P2P system acts as a safeguard against unreliable and/or malicious nodes acting in the decentralized P2P network to undermine the work efforts of the other nodes, e.g., by providing byzantine fault tolerance within the network.

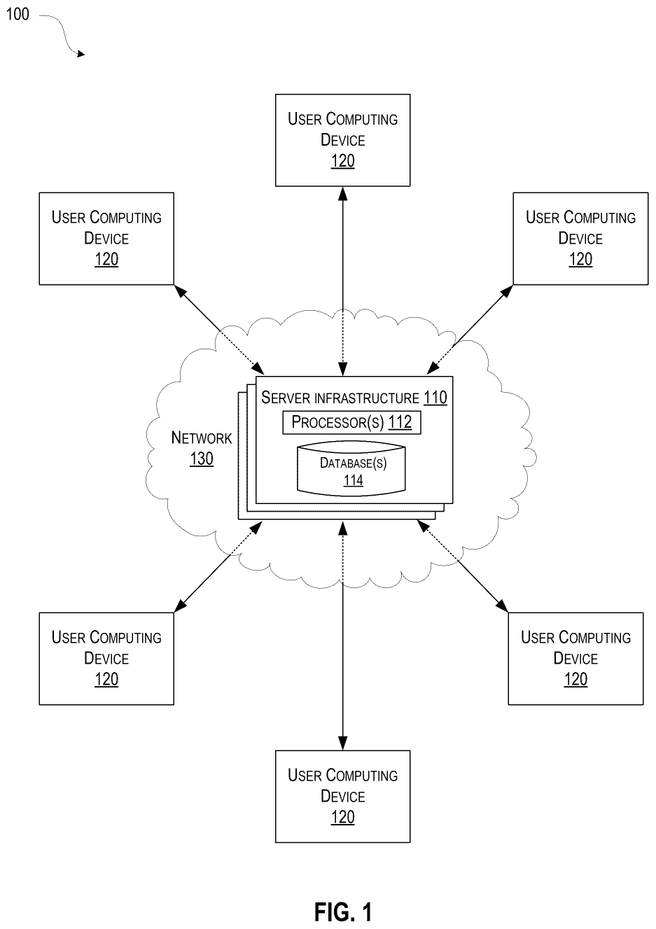

FIG. 1 depicts an illustrative example of centralized computer system 100 in accordance with one or more illustrative aspects described herein. Centralized computer system 100 may comprise one or more computing devices including at least server infrastructure 110 and user computing devices 120. Each of user computing devices 120 may be configured to communicate with server infrastructure 110 through network 130. In some arrangements, centralized computer system 100 may include additional computing devices and networks that are not depicted in FIG. 1, which also may be configured to interact with server infrastructure 110 and, in some instances, user computing devices 120.

Server infrastructure 110 may be associated with a distinct entity such as a company, school, government, and the like, and may comprise one or more personal computer(s), server computer(s), hand-held or laptop device(s), multiprocessor system(s), microprocessor-based system(s), set top box(es), programmable consumer electronic device(s), network personal computer(s) (PC), minicomputer(s), mainframe computer(s), distributed computing environment(s), and the like. Server infrastructure 110 may include computing hardware and software that may host various data and applications for performing tasks of the centralized entity and for interacting with user computing devices 120, as well as other computing devices. For example, each of the computing devices comprising server infrastructure 110 may include at least one or more processors 112 and one or more databases 114, which may be stored in memory of the one or more computing devices of server infrastructure 110. Through execution of computer-readable instructions stored in memory, the computing devices of server infrastructure 110 may be configured to perform functions of the centralized entity and store the data generated during the performance of such functions in databases 114.

In some arrangements, server infrastructure 110 may include and/or be part of enterprise information technology infrastructure and may host a plurality of enterprise applications, enterprise databases, and/or other enterprise resources. Such applications may be executed on one or more computing devices included in server infrastructure 110 using distributed computing technology and/or the like. In some instances, server infrastructure 110 may include a relatively large number of servers that may support operations of a particular enterprise or organization, such as a financial institution. Server infrastructure 110, in this embodiment, may generate a single centralized ledger for data received from the various user computing devices 120, which may be stored in databases 114.

Each of the user computing devices 120 may be configured to interact with server infrastructure 110 through network 130. In some instances, one or more of the user computing devices 120 may be configured to receive and transmit information corresponding to system requests through particular channels and/or representations of webpages and/or applications associated with server infrastructure 110. The system requests provided by user computing devices 120 may initiate the performance of particular computational functions such as data and/or file transfers at server infrastructure 110. In such instances, the one or more of the user computing devices may be internal computing devices associated with the particular entity corresponding to server infrastructure 110 and/or may be external computing devices which are not associated with the particular entity.

As stated above, centralized computer system 100 also may include one or more networks, which may interconnect one or more of server infrastructure 110 and one or more user computing devices 120. For example, centralized computer system 100 may include network 130. Network 130 may include one or more sub-networks (e.g., local area networks (LANs), wide area networks (WANs), or the like). Furthermore, the centralized computer system 100 may include a local network configured to interlink each of the computing devices comprising server infrastructure 110.

Furthermore, in some embodiments, the centralized computer system 100 may include a plurality of computer systems arranged in an operative networked communication arrangement with one another through a network, which may interface with server infrastructure 110, user computing devices 120, and/or the network 130. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

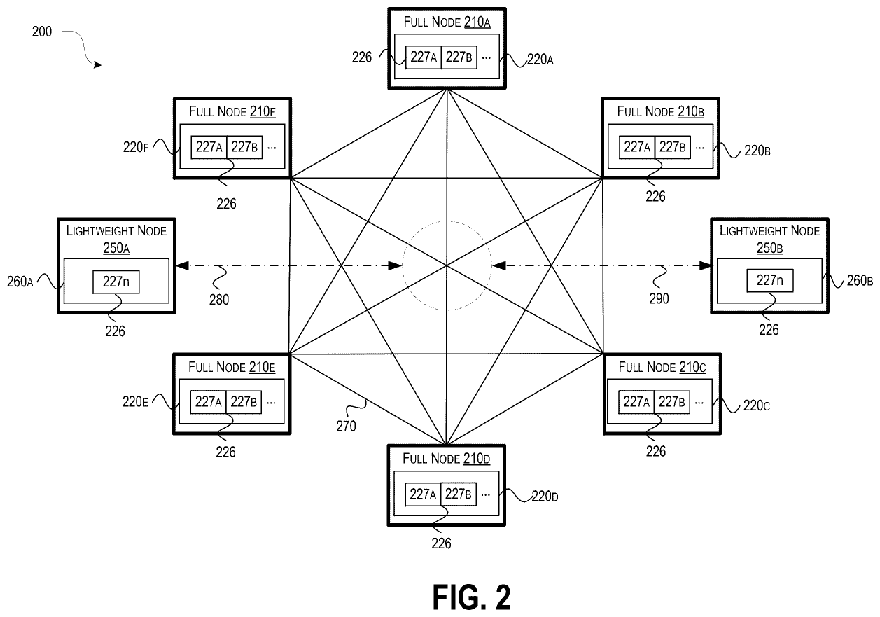

In the centralized computer system 100 described in regard to FIG. 1, the server infrastructure 110 may serve as a central authority which manages at least a portion of the computing data and actions performed in relation to the particular entity associated with the server infrastructure 110. As such, the server infrastructure 110 of the centralized computer system 100 provides a single point of failure which, if compromised by a malicious attacker, can lead to data tampering, unauthorized data disclosure, and illicit use and/or loss of operative control of the processes performed by the server infrastructure 110 in relation to the particular entity associated with the server infrastructure 110. In such a centralized construct in which a single point of failure (e.g., the server infrastructure 110) is created, significant technological problems arise regarding maintenance of operation and data control, as well as preservation of data integrity. As will be described in further detail below in regard to FIG. 2, such technological problems existing in centralized computing arrangements may be solved by a decentralized P2P system implementing a blockchain data structure, even wholly within the server infrastructure 110.

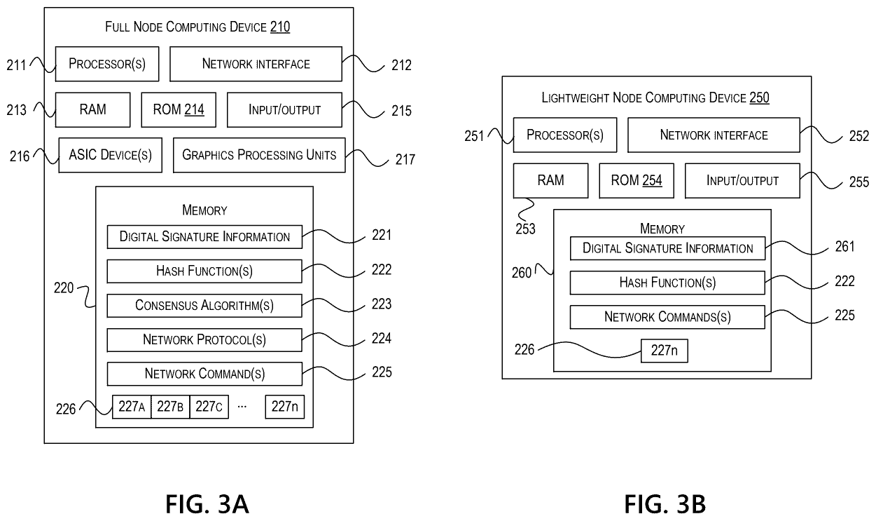

FIG. 2 depicts an illustrative example of a decentralized P2P computer system 200 that may be used in accordance with one or more illustrative aspects described herein. The decentralized P2P computer system 200 may include a plurality of full node computing devices 210A, 210B, 210C, 210D, 210E, and 210F, and lightweight node computing devices 250A and 250B, which may be respectively similar to full node computing device 210 described in regard to FIG. 3A and lightweight node computing device 250 described in regard to FIG. 3B. While a particular number of full node computing devices and lightweight node computing devices are depicted in FIG. 2, it should be understood that a number of full node computing devices and/or lightweight node computing devices greater or less than that of the depicted full node computing devices and lightweight node computing devices may be included in the decentralized P2P computer system 200. Accordingly, any additional full node computing devices and/or lightweight node computing devices may respectively perform in the manner described below in regard to the full node computing devices 210A-210F and the lightweight node computing devices 250A and 250B in the decentralized P2P computer system 200.

Each of the full node computing devices 210A-210F may operate in concert to create and maintain the decentralized P2P network 270 of the decentralized P2P computer system 200. In creating the decentralized P2P network 270 of the decentralized P2P computer system 200, processors, ASIC devices, and/or graphics processing units (e.g., GPUs) of each full node computing device 210A-210F may execute network protocols which may cause each full node computing device 210A-210F to form a communicative arrangement with the other full node computing devices 210A-210F in the decentralized P2P computer system 200 and thereby create decentralized P2P network 270. Furthermore, the execution of network protocols by the processors, ASIC devices, and/or GPUs of the full node computing devices 210A-210F may cause the full node computing devices 210A-210F to execute network functions related to the blockchain 226 and maintain the decentralized P2P network 270.

The lightweight node computing devices 250A and 250B may request execution of network functions related to the decentralized P2P network 270. To request execution of network functions, such as balance sheet transaction and/or smart contract operations, processors of the lightweight node computing devices 250A and 250B may execute network commands to broadcast the network functions to the decentralized P2P network 270 comprising the full node computing devices 210A-210F.

For example, the lightweight node computing device 250A may request execution of a balance sheet transaction related to the decentralized P2P network 270, which may entail a data transfer from a wallet associated with the lightweight node computing device 250A to a wallet associated with the lightweight node 250B. In doing so, processors of the lightweight node computing device 250A may execute network commands to broadcast the balance sheet transaction network function request 280 to the decentralized P2P network 270. The balance sheet transaction network function request 280 may include details about the data transfer such as data type and amount, as well as a data transfer amount to the full node computing devices 210A-201F of the decentralized P2P network 270 for executing balance sheet transaction network function request 280. Balance sheet transaction network function request 280 may further include the public key associated with the wallet of lightweight node computing device 250B. Processors of the lightweight node computing device 250A may execute digital signature algorithms to digitally sign balance sheet transaction network function request 280 with the private key associated with the wallet of lightweight node computing device 250A.

At the decentralized P2P network 270, the balance sheet transaction network function request 280 may be broadcasted to each of the full node computing devices 210A-210F through execution of network protocols by the full node computing devices 210A-210F. In order to execute the balance sheet transaction network function request 280 and maintain inter-nodal agreement as to the state of the blockchain 226, processors, ASIC devices, and/or GPUs of full node computing devices 210A-210F may execute network protocols to receive broadcast of the network function through the decentralized P2P network 270 and from the lightweight node computing device 250A. Processors, ASIC devices, and/or GPUs of the full node computing devices 210A-210F may execute hash functions to generate a digest of balance sheet transaction network function request 280. The resultant digest of the balance sheet transaction network function request 280 may, in turn, be hashed with the block hash of the most immediately preceding block of the blockchain 226. Processors, ASIC devices, and/or GPUs of the full node computing devices 210A-210F may execute consensus algorithms to identify a numerical value (e.g., nonce) corresponding to the particular executed consensus algorithm and related to the digest that combines the digest of the balance sheet transaction network function request 280 and the block hash of the most immediately preceding block of the blockchain 226.

For example, in embodiments in which the consensus algorithm is proof of work (e.g., PoW), processors, ASIC devices, and/or GPUs of the full node computing devices 210A-210F may perform a plurality of hashing operations to identify a nonce that, when hashed with the digest that combines the digest of the balance sheet transaction network function request 280 and the block hash of the most immediately preceding block of the blockchain 226, produces a hash of a predetermined alphanumerical format. Such a predetermined alphanumerical format may include a predetermined number of consecutive alphanumerical characters at a predetermined position within the resultant digest that combines the nonce, digest of the balance sheet transaction network function request 280, and block hash of the most immediately preceding block of the blockchain 226.

In embodiments in which the consensus algorithm is proof of stake (e.g., PoS), a private key associated with one of the full node computing devices 210A-210F may be pseudo-randomly selected, based on balance sheet holdings associated with the public keys of the full node computing devices 210A-210F, to serve as the nonce. For example, through execution of the PoS consensus algorithm, the full node computing devices 210A-210F are entered into a lottery in which the odds of winning are proportional to a balance sheet amount associated the wallet of each of the full node computing devices 210A-210F, wherein a larger balance sheet amount corresponds to a higher probability to win the lottery. The PoS consensus algorithm may cause a full node computing device from the full node computing devices 210A-210F to be selected, and the public key of the wallet of the selected full node computing device to be used as the nonce.

In embodiments in which the consensus algorithm is delegated proof of stake (e.g., DpoS), a group of delegates are chosen from the full node computing devices 210A-210F by each of the computing devices 210A-210F, wherein the full node computing devices 210A-210F are allowed to select candidate delegates based on balance sheet holdings associated with the respective wallets. The full node computing devices 210A-210F, however, may not select themselves to be delegates. Once the group of delegates are chosen, the group of delegates from the full node computing devices 210A-210F select a public key associated with a wallet of one of the full node computing devices 210A-210F to serve as the nonce.

In embodiments in which the consensus algorithm is practical byzantine fault tolerance algorithm (e.g., PBFT), each of the full node computing devices 210A-210F are associated with a particular status and/or ongoing specific information associated with the respective public key of the full node computing devices. Each of the full node computing devices 210A-210F receive a message through the decentralized P2P network 270 based on network protocols. Based on the received message and particular status and/or ongoing specific information, each of the full node computing devices 210A-210F perform computational tasks and transmit a response to the tasks to each of the other full node computing devices 210A-210F. A public key of a wallet associated with a particular full node computing device from the full node computing devices 210A-210F is selected by each of the full node computing devices 210A-210F based on the response of the particular full node computing device best fulfilling criteria determined based on the network protocols.

The identification of the nonce enables processors, ASIC devices, and/or GPUs of the full node computing device from the full node computing devices 210A-210F corresponding to the nonce to create a new block with a block header (e.g., block hash), which is a digest that combines the digest of the balance sheet transaction network function request 280, the block hash of the most immediately preceding block, and the identified nonce. Processors, ASIC devices, and/or GPUs of the full node computing device from the full node computing devices 210A-210F may execute network protocols to add the new block to the blockchain 226 and broadcast the new block to the other full node computing devices in the decentralized P2P network 270. In some arrangements, the new block may also be time-stamped at a time corresponding to the addition to the blockchain 226. Furthermore, as a reward for adding the new block to the blockchain 226, the full node computing device from the full node computing devices 210A-210F may be allowed, per the network protocols, to increase balance sheet holdings associated with itself by a predetermined amount. In some arrangements, each of the full node computing devices 210A-210F may receive an equal portion of the data transfer amount specified by the lightweight node computing device 250A for executing the balance sheet transaction network function request 280. After the new block has been added to the blockchain 226, the balance sheet transaction network function request 280 may be considered to be executed and the data transfer from the wallet associated with the lightweight node computing device 250A to the wallet associated with the lightweight node 250B may be registered.

As stated above, in some arrangements, a plurality of network function requests may be broadcasted across the decentralized network P2P network 270. Processors, ASIC devices, and/or GPUs of the full node computing devices 210A-210F may execute network protocols to receive broadcast of each of the network functions, including the balance sheet transaction network function request 280, through the decentralized P2P network 270 and from the requesting entities, including the lightweight node computing device 250A. Processors, ASIC devices, and/or GPUs of the full node computing devices 210A-210F may execute hash functions to generate a hash tree (e.g., Merkle tree) of the requested network functions, which culminates in a single digest (e.g., root digest, root hash, and the like) that comprises the digests of each of the requested network functions, including the balance sheet transaction network function request 280. The root digest of the requested network function may, in turn, be hashed with the block hash of the most immediately preceding block of the blockchain 226. Processors, ASIC devices, and/or GPUs of the full node computing devices 210A-210B may execute consensus algorithms in the manner described above to identify a nonce corresponding to the particular executed consensus algorithm and related to the digest that combines the root digest of the requested network functions and the block hash of the most immediately preceding block of the blockchain 226. The identification of the nonce enables processors, ASIC devices, and/or GPUs of the full node computing device from the full node computing devices 210A-210F to create a new block with a block header (e.g., block hash), which is a digest that combines the root digest of the network function requests, the block hash of the most immediately preceding block, and the identified nonce. Processors, ASIC devices, and/or GPUs of the full node computing device from the full node computing devices 210A-210F may execute network protocols to add the new block to the blockchain 226 and broadcast the new block to the other full node computing devices in the decentralized P2P network 270. In some arrangements, the new block may also be time-stamped at a time corresponding to the addition to the blockchain 226. Furthermore, as a reward for adding the new block to the blockchain 226, the full node computing device from the full node computing devices 210A-210F may be allowed, per the network protocols, to increase a balance sheet holdings amount associated with itself by a predetermined amount. In some arrangements, each of the full node computing devices 210A-210F may receive an equal portion of the data transfer amount specified by each of the network function requests. After the new block has been added to the blockchain 226, each of the network functions requests, including the balance sheet transaction network function request 280, may be considered to be executed and the data transfer from the private/public key associated with the lightweight node computing device 250A to the private/public key associated with the lightweight node 250B may be registered.

While the description provided above is made in relation to a balance sheet transaction involving the lightweight node computing device 250A and the lightweight node computing device 250B, it is to be understood that balance sheet transactions are not limited to the lightweight node computing device 250A and the lightweight node computing device 250B, but rather may be made across any of the full node computing devices and/or lightweight node computing devices in the decentralized P2P system 200.

For another example, the lightweight node computing device 250B may request a smart contract operation related to the decentralized P2P network 270, which may facilitate a dual data transfer between a wallet associated with the lightweight node computing device 250B and a wallet associated with another node in the decentralized P2P network 270, such as the lightweight node computing device 250A, based on fulfillment of programmatic conditions established by a smart contract. Processors of the lightweight node computing device 250B may execute network commands to broadcast the smart contract operation network function request 290 to the decentralized P2P network 270. The smart contract operation network function request 290 may include details about the data transfer such as data type and amount, as well as a data transfer amount to the full node computing devices 210A-210F of decentralized P2P network 270 for executing the smart contract corresponding to the smart contract operation network function request 290. The smart contract operation network function request 290 may further include the public key associated with the smart contract. Processors of the lightweight node computing device 250B may execute digital signature algorithms to digitally sign the smart contract operation network function request 290 with the private key associated with the wallet of the lightweight node computing device 250B.

At the decentralized P2P network 270, the smart contract operation network function request 290 may be broadcasted to each of the full node computing devices 210A-210F through execution of network protocols by the full node computing devices 210A-210F. In order to execute the smart contract operation network function request 290 and maintain inter-nodal agreement as to the state of the blockchain 226, processors, ASIC devices, and/or GPUs of full node computing devices 210A-210F may execute network protocols to receive broadcast of the network function through a decentralized P2P network 270 and from the lightweight node computing device 250B. Processors, ASIC devices, and/or GPUs of the full node computing devices 210A-210F may execute hash functions to generate a digest of the smart contract operation network function request 290. The resultant digest of the smart contract operation network function request 290, in turn, may be hashed with the block hash of the most immediately preceding block of the blockchain 226. Processors, ASIC devices, and/or GPUs of full node computing devices 210A-210F may execute consensus algorithms to identify a nonce corresponding to the particular executed consensus algorithm and related to the digest that combines the digest of the smart contract operation network function request 290 and the block hash of the most immediately preceding block of the blockchain 226.

The identification of the nonce enables processors, ASIC devices, and/or GPUs of the full node computing device from the full node computing devices 210A-210F to create a new block with a block header (e.g., block hash), which is a digest that combines the smart contract operation network function request 290, the block hash of the most immediately preceding block, and the identified nonce. Processors, ASIC devices, and/or GPUs of the full node computing device from the full node computing devices 210A-210F may execute network protocols to add the new block to the blockchain 226 and broadcast the new block to the other full node computing devices in the decentralized P2P network 270. In some arrangements, the new block may also be time-stamped at a time corresponding to the addition to the blockchain 226. Furthermore, as a reward for adding the new block to the blockchain 226, the full node computing device from the full node computing devices 210A-210F may, per the network protocols, increase a balance sheet holdings amount associated with itself by a predetermined amount. In some arrangements, each of the full node computing devices 210A-210F may receive an equal portion of the data transfer amount specified by the lightweight node computing device 250B for executing the smart contract operation network function request 290. After the new block has been added to the blockchain 226, the smart contract operation request 290 may be considered to be executed and the data transfer from the wallet associated with the lightweight node computing device 250B to the public key associated with the smart contract may be registered.

The smart contract may be configured to hold the data transfer from the wallet associated with the lightweight node computing device 250B until fulfillment of certain predetermined criteria hardcoded into the smart contract are achieved. The smart contract may be configured such that it serves as an intermediate arbiter between entities within the decentralized P2P network 270 and may specify details of a dual data transfer between entities.

For example, the smart contract corresponding to the smart contract operation request 290 may be one or more algorithms and/or programs stored on a block of the blockchain 226. The smart contract may be identified by one or more wallets and/or public keys within the decentralized P2P network 270. The lightweight node computing device 250B may transmit the smart contract operation network function request 290 to the decentralized P2P network 270, which may cause execution of the corresponding smart contract that facilitates a dual data transfer between a wallet associated with the lightweight node computing device 250B and a wallet associated with another node in the decentralized P2P network 270, such as the lightweight node computing device 250A, based on fulfillment of programmatic conditions established by the smart contract. In the processes of adding the block comprising the smart contract operation request 290 to the blockchain 226, each of the full node computing devices 210A-210F may identify the block within the blockchain 226 comprising the smart contract, associate the data transfer entailed by the smart contract operation request 290 with the smart contract, and execute the one or more algorithms and/or programs of the smart contract. In this instance, given that the smart contract facilitates a dual data transfer and that data transfer has yet to be received from another node (e.g., the lightweight node computing device 250A), each of the full node computing devices 210A-210F may execute the smart contract without fulfillment of the programmatic conditions established by the smart contract. Accordingly, the funds transferred by the lightweight node computing device 250B may remain in the smart contract until the data transfer from the other node is also associated with the smart contract.

Moving forward, the lightweight node computing device 250A may also request a smart contract operation related to the decentralized P2P network 270, which may conclude the dual data transfer between the wallet associated the lightweight node computing device 250A and the wallet associated with the lightweight node computing device 250B. Processors of the lightweight node computing device 250A may execute network commands to broadcast the smart contract operation network function request to the decentralized P2P network 270. The smart contract operation network function request may include details about the data transfer such as data type and amount, as well as a data transfer amount to the full node computing devices 210A-210F of the decentralized P2P network 270 for executing the smart contract corresponding to the smart contract operation network function request. The smart contract operation network function request may further include the public key associated with the smart contract. Processors of the lightweight node computing device 250A may execute digital signature algorithms to digitally sign the smart contract operation network function request with the private key associated with the wallet of the lightweight node computing device 250A.

At the decentralized P2P network 270, the smart contract operation network function request may be broadcasted to each of the full node computing devices 210A-210F through execution of network protocols by the full node computing devices 210A-210F. In order to execute the smart contract operation network function request and maintain inter-nodal agreement as to the state of the blockchain 226, processors, ASIC devices, and/or GPUs of full node computing devices 210A-210F may execute network protocols to receive broadcast of the network function through a decentralized P2P network 270 and from the lightweight node computing device 250A. Processors, ASIC devices, and/or GPUs of the full node computing devices 210A-210F may execute hash functions to generate a digest of the smart contract operation network function request. The resultant digest of the smart contract operation network function request, in turn, may be hashed with the block hash of the most immediately preceding block of the blockchain 226. Processors, ASIC devices, and/or GPUs of the full node computing devices 210A-210F may execute consensus algorithms to identify a nonce corresponding to the particular executed consensus algorithm and related to the digest that combines the digest of the smart contract operation network function request and the block hash of the most immediately preceding block of the blockchain 226.

The identification of the nonce enables processors, ASIC devices, and/or GPUs of the full node computing device from the full node computing devices 210A-210F to create a new block with a block header (e.g., block hash), which is a digest that combines the smart contract operation network function request, the block hash of the most immediately preceding block, and the identified nonce. Processors, ASIC devices, and/or GPUs of the full node computing device from the full node computing devices 210A-210F may execute network protocols to add the new block to the blockchain 226 and broadcast the new block to the other full node computing devices in the decentralized P2P network 270. In some arrangements, the new block may also be time-stamped at a time corresponding to the addition to the blockchain 226. Furthermore, as a reward for adding the new block to the blockchain 226, the full node computing device from the full node computing devices 210A-210F may be allowed, per the network protocols, to increase a balance sheet holdings amount associated with itself by a predetermined amount. In some arrangements, each of the full node computing devices 210A-210F may receive an equal portion of the data transfer amount specified by the lightweight node computing device 250A for executing the smart contract operation network function request. After the new block has been added to the blockchain 226, the smart contract operation transaction network function request 290 may be considered to be executed and the data transfer from the wallet associated with the lightweight node computing device 250A to the public key associated with the smart contract may be registered.

When the smart contract receives the data value from each of the lightweight node computing device 250A and the lightweight node computing device 250B, the execution of the smart contract by each of the full node computing devices 210A-210F may cause transfer of the data value from the lightweight node computing device 250A to the lightweight node computing device 250B and the data value from the lightweight node computing device 250B to the lightweight node computing device 250A.

For example, the lightweight node computing device 250A may transmit the smart contract operation network function request to the decentralized P2P network 270, which may cause execution of the corresponding smart contract that facilitates the dual data transfer. In the process of adding the block comprising the smart contract operation request provided by the lightweight node computing device 250A to the blockchain 226, each of the full node computing devices 210A-210F may identify the block within the blockchain 226 comprising the smart contract, associate the data transfer entailed by smart contract operation request of the lightweight node computing device 250A with the smart contract, and execute the one or more algorithms and/or programs of the smart contract. In this instance, given that the smart contract facilitates a dual data transfer and that data transfers have been received from the lightweight node computing device 250A and the lightweight node computing device 250B, each of the full node computing devices 210A-210F may execute the smart contract as fulfillment of the programmatic conditions established by the smart contract has occurred. Accordingly, the funds allocated to the smart contract by each of the lightweight node computing device 250A and the lightweight node computing device 250B may be respectively distributed to the intended counterparty.

While the description provided above was made in relation to the lightweight node computing device 250A and the lightweight node computing device 250B, it should be understood that any of the full node computing devices and lightweight node computing devices in the decentralized system 200 may participate in the smart contract. Furthermore, it should be understood that the smart contract may be able to fulfill dual data transfers in the manner described above across a plurality of entities entering into the smart contract. For example, a first plurality of entities may enter into the smart contract, which may hold the data values for each of the first plurality of entities until a second plurality of entities enter into the smart contract. When each of the first plurality of entities and the second plurality of entities have entered, the smart contract may perform the data transfer. Other smart contracts may be included which include algorithms, programs, and/or computer-executable instructions which cause the performance of one or more functions related to at least cryptocurrency, digital content storage and delivery, entity authentication and authorization, digital identity, marketplace creation and operation, internet of things (e.g., IoT), prediction platforms, balloting, well-being records, currency exchange and remittance, P2P transfers, ride sharing, participatory electronic entertainment, trading platforms, and real estate, precious metal, and work of art registration and transference.

In comparison to the centralized computing system 100 described in regard to FIG. 1, the decentralized P2P computer system 200 may provide technological advantages. For example, by distributing storage of the blockchain 226 across the multiple full node computing devices 210A-210F, the decentralized P2P computer system 200 may not provide a single point of failure for malicious attack. In the event that any of the full node computing devices 210A-210F are compromised by a malicious attacker, the decentralized P2P computer system 200 may continue to operate unabated as data storage of the blockchain 226 and performance of network processes are not controlled by a singular entity such as the server infrastructure 110 of the centralized computing system 100.

Furthermore, by utilizing the blockchain data structure 226, the decentralized P2P system 200 may provide technological improvements to conventional decentralized P2P systems in regard to byzantine fault tolerance stemming from an unreliable and/or malicious full node acting in the decentralized P2P network 270 to undermine the work efforts of the other nodes. For example, in coordinating action between the full node computing devices 210A-210F in relation to a similar computational task (e.g., consensus algorithm), a malicious node would need to have computational power greater than the combined computational power of each of the other full node computing devices in the decentralized P2P network 270 to identify the nonce and thereby be able to modify the blockchain 226. As such, the likelihood that a malicious node could subvert the decentralized P2P network 270 and enter falsified data into the blockchain 226 is inversely proportional to the total computational power of the decentralized P2P system 200. Therefore, the greater the total computational power of the decentralized P2P system 200, the less likely that a malicious node could subvert the decentralized P2P network 270 and undermine the blockchain 226.

FIG. 3A depicts an illustrative example of a full node computing device 210 that may be used in accordance with one or more illustrative aspects described herein. The full node computing device 210 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, the full node computing device 210 may be configured to operate in a decentralized P2P network and may request execution of network functions and/or to execute requested network functions and maintain inter-nodal agreement as to the state of a blockchain of the decentralized P2P network.

The full node computing device 210 may include one or more processors 211, which control overall operation, at least in part, of the full node computing device 210. The full node computing device 210 may further include random access memory (RAM) 213, read only memory (ROM) 214, network interface 212, input/output interfaces 215 (e.g., keyboard, mouse, display, printer, and the like), and memory 220. The input/output (I/O) 215 may include a variety of interface units and drives for reading, writing, displaying, and/or printing data or files. In some arrangements, the full node computing device 210 may further comprise specialized hardware components such as the application-specific integrated circuit (e.g., ASIC) devices 216 and/or the graphics processing units (e.g., GPUs) 217. Such specialized hardware components may be used by the full node computing device 210 in performing one or more of the processes involved in the execution of requested network functions and maintenance of inter-nodal agreement as to the state of a blockchain. The full node computing device 210 may further store in memory 220 operating system software for controlling overall operation of the full node computing device 210, control logic for instructing the full node computing device 210 to perform aspects described herein, and other application software providing secondary, support, and/or other functionality which may or might not be used in conjunction with aspects described herein.

The memory 220 may also store data and/or computer executable instructions used in performance of one or more aspects described herein. For example, the memory 220 may store digital signature information 221 and one or more hash functions 222, consensus algorithms 223, network protocols 224, and network commands 225. In some arrangements, the digital signature information 221, the hash functions 222, and/or the network commands 225 may comprise a wallet of the full node computing device 210. The memory 220 may further store the blockchain 226. Each of the digital signature information 221, the hash functions 222, the consensus algorithms 223, the network protocols 224, and the network commands 225 may be used and/or executed by the one or more processors 211, the ASIC devices 216, and/or the GPUs 217 of the full node computing device 210 to create and maintain a decentralized P2P network, request execution of network functions, and/or execute requested network functions and maintain inter-nodal agreement as to the state of the blockchain 226.

For example, in order to create and maintain a decentralized P2P network, the processors 211, the ASIC devices 216, and/or the GPUs 217 of the full node computing device 210 may execute the network protocols 225. Execution of the network protocols 225 may cause the full node computing device 210 to form a communicative arrangement with other full node computing devices and thereby create a decentralized P2P network. Furthermore, the execution of the network protocols 225 may cause the full node computing device 210 to maintain the decentralized P2P network through the performance of computational tasks related to the execution of network requests related to a blockchain such as the blockchain 226. As will be described in detail below, the execution of such computational tasks (e.g., the hash functions 222, the consensus algorithms 223, and the like) may cause the full node computing device 210 to maintain inter-nodal agreement as to the state of a blockchain with other full node computing devices comprising the decentralized P2P network.

In order to request execution of network functions, such as smart contract operations, the processors 211, the ASIC devices 216, and/or the GPUs 217 of the full node computing device 210 may execute the network commands 225 to broadcast the network function to a decentralized P2P network comprising a plurality of full nodes and/or lightweight nodes. The request may be digitally signed by the full node computing device 210 with usage of the private/public key information and through execution of the digital signature algorithms of the digital signature information 221.

In order to execute requested network functions and maintain inter-nodal agreement as to the state of a blockchain, the processors 211, the ASIC devices 216, and/or the GPUs 217 of the full node computing device 210 may execute the network protocols 224 to receive a broadcast of a requested network function through a decentralized P2P network and from a requesting entity such as a full node or lightweight node. The processors 211, the ASIC devices 216, and/or the GPUs 217 of the full node computing device 210 may execute hash functions 222 to generate a digest of the requested network function. The resultant digest of the requested network function, in turn, may be hashed with the block hash of the most immediately preceding block of the blockchain. As will be described in further detail below, the processors 211, the ASIC devices 216, and/or the GPUs 217 of the full node computing device 210 may execute the consensus algorithms 223 to identify a numerical value (e.g., nonce) corresponding to the particular executed consensus algorithm and related to the digest that combines the digest of the requested network function and the block hash of the most immediately preceding block of the blockchain. The identification of the numerical value enables the processors 211, the ASIC devices 216, and/or the GPUs 217 of the full node computing device 210 to create a new block with a block header (e.g., block hash), which is a digest that combines the digest of the requested network function, the block hash of the most immediately preceding block, and the identified nonce. The processors 211, the ASIC devices 216, and/or the GPUs 217 of full node computing device 210 may add the new block to the blockchain based on the network protocols 224 and broadcast the new block to the other nodes in the decentralized P2P network.

As stated above, in some arrangements, a plurality of network function requests may be broadcasted across the decentralized P2P network. The processors 211, the ASIC devices 216, and/or the GPUs 217 of the full node computing device 210 may execute the network protocols 224 to receive broadcast of each of the network functions through the decentralized P2P network and from the requesting entities. The processors 211, the ASIC devices 216, and/or the GPUs 217 of the full node computing device 210 may execute the hash functions 222 to generate a hash tree (e.g., Merkle tree) of the requested network functions, which culminates in a single digest (e.g., root digest, root hash, and the like) that comprises the digests of each of the requested network functions. The root digest of the requested network function, in turn, may be hashed with the block hash of the most immediately preceding block of the blockchain. The processors 211, the ASIC devices 216, and/or the GPUs 217 of full node computing device 210 may execute the consensus algorithms 223 to identify a numerical value (e.g., nonce) corresponding to the particular executed consensus algorithm and related to the digest that combines the root digest of the requested network functions and the block hash of the most immediately preceding block of the blockchain. The identification of the numerical value enables the processors 211, the ASIC devices 216, and/or the GPUs 217 of the full node computing device 210 to create a new block with a block header (e.g., block hash), which is a digest that combines the root digest of the requested network functions, the block hash of the most immediately preceding block, and the identified nonce. The processors 211, the ASIC devices 216, and/or the GPUs 217 of the full node computing device 210 may add the new block to the blockchain based on the network protocols 224 and broadcast the new block to the other nodes in the decentralized P2P network.

Furthermore, the memory 220 of the full node computing device 210 may store the blockchain 226. The blockchain 226 may include the blocks 227A, 227B, 227C, . . . 227n, wherein the block 227A represents the first block (e.g., genesis block) of the blockchain 226 and the block 227n represents the most immediate block of the blockchain 226. As such, the blockchain 226, which may be a replica or copy of the blockchain of the decentralized P2P network in which the full node computing device 210 operates, may be a full or complete copy of the blockchain of the decentralized P2P network. Each of the blocks within the blockchain 226 may include information corresponding to the one or more network functions executed by the decentralized P2P network. As such, the blockchain 226 as stored in the memory 220 of the full node computing device 210 may comprise the totality of network functions executed by the decentralized network.

FIG. 3B depicts an illustrative example of a lightweight node computing device 250 that may be used in accordance with one or more illustrative aspects described herein. The lightweight node computing device 250 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, the lightweight node computing device 250 may operate in a decentralized P2P network and may be configured to request execution of network functions through the decentralized P2P network. As such, the lightweight node computing device 250 may be different than the full node computing device 210 in that it is not configured to execute network functions and/or operate to maintain a blockchain of a decentralized P2P network. In other aspects, the lightweight node computing device 250 may have substantially the same physical configuration as the full node computing device 210, but configured with different programs, software, and the like.

The lightweight node computing device 250 may include one or more processors 251, which control overall operation of the lightweight node computing device 250. The lightweight node computing device 250 may further include random access memory (RAM) 253, read only memory (ROM) 254, network interface 252, input/output interfaces 255 (e.g., keyboard, mouse, display, printer, and the like), and memory 260. The input/output (I/O) 255 may include a variety of interface units and drives for reading, writing, displaying, and/or printing data or files. The lightweight node computing device 250 may store in the memory 260 operating system software for controlling overall operation of the lightweight node computing device 250, control logic for instructing the lightweight node computing device 250 to perform aspects described herein, and other application software providing secondary, support, and/or other functionality which may or might not be used in conjunction with aspects described herein.

In comparison to full node computing device 210, the lightweight node computing device 250 might not include, in some instances, specialized hardware such as the ASIC devices 216 and/or the GPUs 217. Such is the case because the lightweight node computing device 250 might not be configured to execute network functions and/or operate to maintain a blockchain of a decentralized P2P network as is the full node computing device 210. However, in certain arrangements, the lightweight node computing device 250 may include such specialized hardware.

The memory 260 of the lightweight node computing device 250 may also store data and/or computer executable instructions used in performance of one or more aspects described herein. For example, the memory 260 may store the digital signature information 261 and one or more hash functions 222 and the network commands 225. In some arrangements, the digital signature information 261, the hash functions 222, and/or the network commands 225 may comprise a wallet of lightweight node computing device 250. Each of the hash functions 222 and the network commands 225 stored in the memory 260 of the lightweight node computing device 250 may be respectively similar and/or identical to the hash functions 222, the network commands 225 stored in the memory 220 of the full node computing device 210.

In regard to the digital signature information, each of the digital signature information 261 stored in the memory 260 of the lightweight node computing device 250 and the digital signature information 221 stored in the memory 220 of the full node computing device 210 may comprise similar and/or identical digital signature algorithms. However, the private/public key information of the digital signature information 261 stored in the memory 260 of the lightweight node computing device 250 may be different than that of the private/public key information of the digital signature information 221 stored in the memory 220 of the full node computing device 210. Furthermore, the private/public key information of each node, whether the full or the lightweight, in a decentralized P2P computing network may be unique to that particular node. For example, a first node in a decentralized P2P computing network may have first private/public key information, a second node may have second private/public key information, a third node may have third private/public key information, and so on, wherein each of the private/public key information is unique to the particular node. As such, the private/public key information may serve as a unique identifier for the nodes in a decentralized P2P computing network.

Each of the digital signature information 261, the hash functions 222, and the network commands 225 may be used and/or executed by the one or more processors 251 of the lightweight node computing device 250 to request execution of network functions in a decentralized P2P network. For example, in order to request execution of network functions, such as smart contract operations, the processors 251 of the lightweight node computing device 250 may execute the network commands 225 to broadcast the network function to a decentralized P2P network comprising a plurality of full nodes and/or lightweight nodes. The request may be digitally signed by the lightweight node computing device 250 with usage of the private/public key information and through execution of the digital signature algorithms of the digital signature information 261.

Furthermore, the memory 260 of the lightweight node computing device 250 may store the blockchain 226. The blockchain 226 stored in the memory 260 of the lightweight node computing device 250 may include at least the block 227n, wherein the block 227n represents the most immediate block of the blockchain 226. As such, the blockchain 226, which may be a replica or copy of the blockchain of the decentralized P2P network in which the lightweight node computing device 250 operates, may be a partial or incomplete copy of the blockchain of the decentralized P2P network. In some instances, however, the blockchain 226 may include the blocks 227A, 227B, 227C, . . . 227n, wherein the block 227A represents the first block (e.g., genesis block) of the blockchain 226 and the block 227n represents the most immediate block of the blockchain 226. As such, the blockchain 226 may be a full or complete copy of the blockchain of the decentralized P2P network. Each of the blocks within the blockchain 226 may include information corresponding to the one or more network functions executed by the decentralized P2P network.

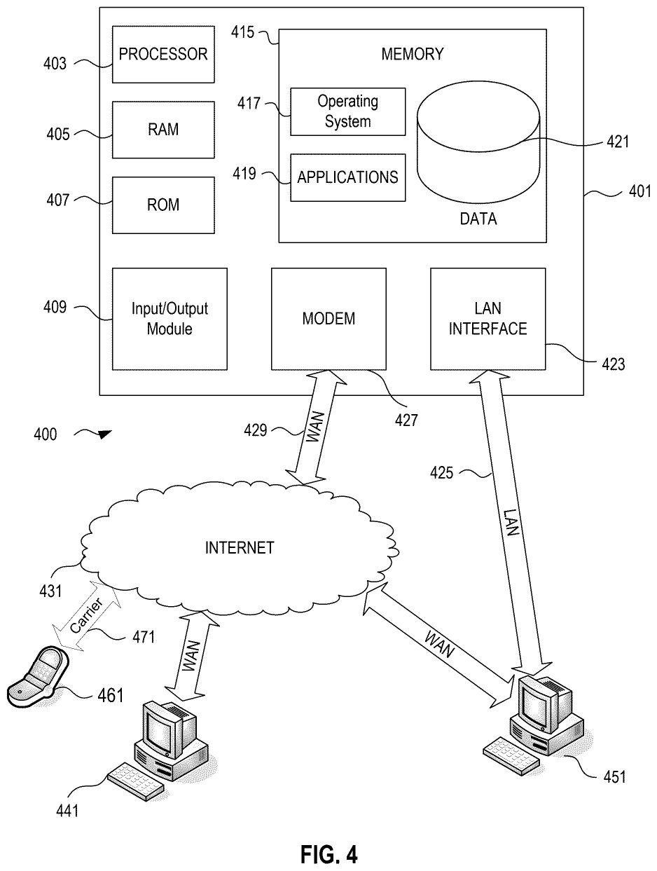

FIG. 4 illustrates an example of a computing system environment 400 that may be used according to one or more illustrative embodiments. The computing system environment 400 is only one example of a suitable computing environment and is not intended to suggest any limitation as to the scope of use or functionality contained in the disclosure. The computing system environment 400 should not be interpreted as having any dependency or requirement relating to any one or combination of components shown in the computing system environment 400.

The disclosure is operational with numerous other general purpose or special purpose computing system environments or configurations. Examples of computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 4, the computing system environment 400 may include a computing device 401 wherein the processes discussed herein may be implemented. The computing device 401 may have a processor 403 for controlling overall operation of the computing device 401 and its associated components, including random-access memory (RAM) 405, read-only memory (ROM) 407, input/output module or communications module 409, and memory 415. The computing device 401 typically includes a variety of computer readable media. Computer readable media may be any available media that may be accessed by the computing device 401 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the computing device 401.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The computing system environment 400 may also include optical scanners (not shown). Exemplary usages include scanning and converting paper documents, e.g., correspondence, receipts to digital files.

Although not shown, the RAM 405 may include one or more applications representing the application data stored in the RAM 405, while the computing device is on and corresponding software applications (e.g., software tasks) are running on the computing device 401.

The communications module 409 may include a microphone, keypad, touch screen, and/or stylus through which a user of the computing device 401 may provide input, and may also include one or more of a speaker for providing audio output and a video display device for providing textual, audiovisual, and/or graphical output.

Software may be stored within the memory 415 and/or storage to provide instructions to the processor 403 for enabling the computing device 401 to perform various functions. For example, memory 415 may store software used by the computing device 401, such as an operating system 417, application programs 419, and an associated database 421. Also, some or all of the computer executable instructions for the computing device 401 may be embodied in hardware or firmware.

The computing device 401 may operate in a networked environment supporting connections to one or more remote computing devices, such as the computing devices 441, 451, and 461. The computing devices 441, 451, and 461 may be personal computing devices or servers that include many or all of the elements described above relative to the computing device 401. The computing device 461 may be a mobile device communicating over the wireless carrier channel 471.

The network connections depicted in FIG. 4 include a local area network (LAN) 425 and a wide area network (WAN) 429, but may also include other networks. When used in a LAN networking environment, the computing device 401 may be connected to the LAN 425 through a network interface, such as LAN interface 423, or to an adapter in the communications module 409. When used in a WAN networking environment, the computing device 401 may include a modem in the communications module 409, a modem separate from the communications module 409, such as the modem 427, or other means for establishing communications over the WAN 429, such as the Internet 431 or other type of computer network. It will be appreciated that the network connections shown are illustrative and other means of establishing a communication link between the computing devices may be used. Various protocols such as TCP/IP, Ethernet, FTP, HTTP and the like may be used, and the system can be operated in a client-server or in Distributed Computing configuration to permit a user to retrieve web pages from a web-based server. Any of various conventional web browsers can be used to display and manipulate data on web pages.

Additionally, one or more application programs 419 used by the computing device 401, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by the computing device 401. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on the computing device 401. Such a processor may execute computer-executable instructions stored on a computer-readable medium. In an example, the systems and apparatus described herein may correspond to the computing device 401. A computer-readable medium (e.g., ROM 407) may store instructions that, when executed by the processor 403, may cause the computing device 401 to perform the functions as described herein.

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

Decentralized finance systems are illustrative applications based on distributed ledgers and are used to provide a fully digital transaction alternative without any associated costs, that could result in more open, free, and fair financial market system for anyone with an internet connection. Other uses for the blockchain may be contemplated, where data immutability and tracking may be desired.

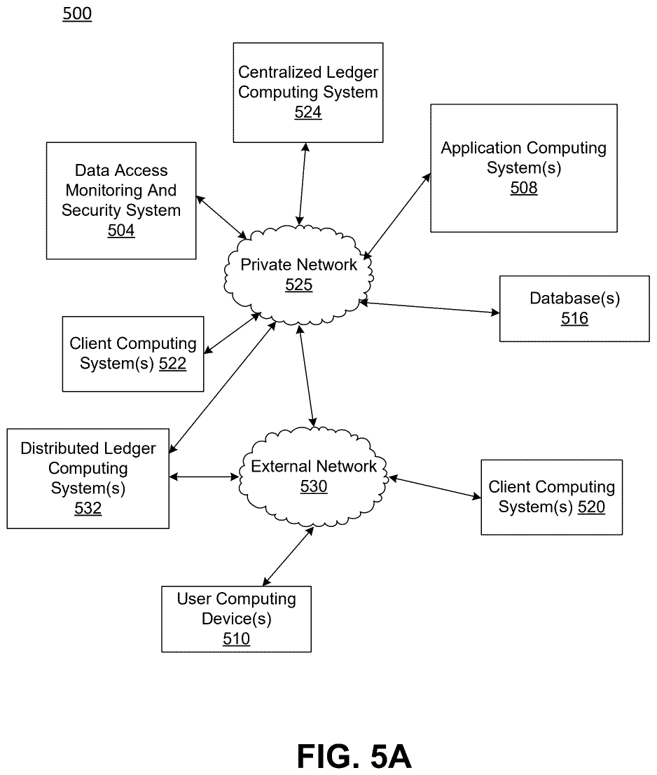

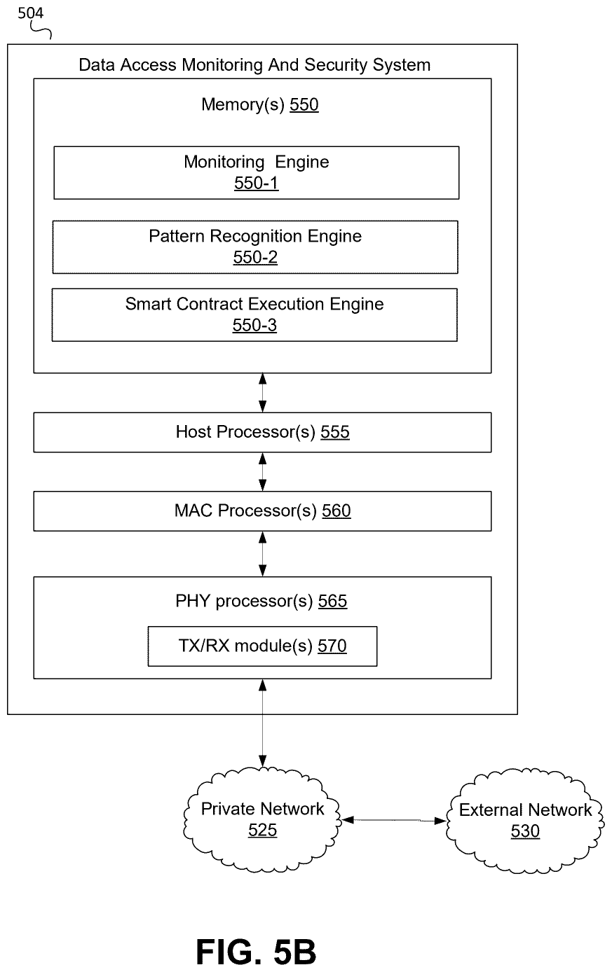

FIG. 5A shows an illustrative computing environment 500 for implementing a system for detecting, monitoring, and reacting to data access events, in accordance with one or more arrangements. The computing environment 500 may comprise one or more devices (e.g., computer systems, communication devices, and the like). The computing environment 500 may comprise, for example, a data access monitoring and security system 504, one or more application computing systems 508, a plurality of user computing devices 510, one or more client computing systems 520 and/or 522, a centralized ledger computing system 524, a distributed ledger computing system 532, and/or one or more database(s) 516. The one or more of the devices and/or systems, may be linked over a private network 525 associated with an enterprise organization (e.g., a financial institution, a business organization, an educational institution, a governmental organization and the like). The computing environment 500 may, for example, comprise a client computing system 520 and one or more user devices 510 connected, via a public network 530, to the devices in the private network 525 and/or the distributed ledger computing system 532 and/or the centralized ledger computing system 524. The devices in the computing environment 500 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.).

The data access monitoring and security system 504 may comprise one or more computing devices and/or other computer components (e.g., processors, memories, communication interfaces) configured to perform one or more functions as described herein. Further details associated with the architecture of the data access monitoring and security system 504 are described with reference to FIG. 5B.

The application computing systems 508 and/or the client computing systems 520 and 522 may comprise one or more computing devices and/or other computer components (e.g., processors, memories, communication interfaces). In addition, the application computing systems 508 and/or the client computing systems 520 and 522 may be configured to host, execute, and/or otherwise provide one or more enterprise applications. In some cases, the application computing systems 508 may host one or more services configured facilitate operations requested through one or more API calls, such as data retrieval and/or initiating processing of specified functionality. In some cases, the client computing system 522 and/or 520 may be configured to communicate with one or more of the application computing systems 508 such as via direct communications and/or API function calls and the services. In an arrangement where the private network 525 is associated with a financial institution (e.g., a bank), the application computing systems 508 may be configured, for example, to host, execute, and/or otherwise provide one or more transaction processing programs, such as an online banking application, fund transfer applications, and/or other programs associated with the financial institution. The application computing systems 508 and/or the client computing systems 520 and 522 may comprise various servers and/or databases that store and/or otherwise maintain account information, such as financial account information including account balances, transaction history, account owner information, and/or other information. In addition, the application computing systems 508 and/or the client computing systems 520 and 522 may process and/or otherwise execute transactions on specific accounts based on commands and/or other information received from other computer systems comprising the computing environment 500. In some cases, one or more of the application computing systems 508 and/or the client computing systems 520 and 522 may be configured, for example, to host, execute, and/or otherwise provide one or more transaction processing programs, such as electronic fund transfer applications, online loan processing applications, and/or other programs associated with the financial institution.

The application computing systems 508 may be one or more host devices (e.g., a workstation, a server, and the like) or mobile computing devices (e.g., smartphone, tablet). In addition, an application computing systems 508 may be linked to and/or operated by a specific enterprise user (who may, for example, be an employee or other affiliate of the enterprise organization) who may have administrative privileges to perform various operations within the private network 525. In some cases, the application computing systems 508 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 520 and/or 522 may comprise one or more computing devices and/or other computer components (e.g., processors, memories, communication interfaces). The client computing systems 520 and/or 522 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 520 and/or 522 is for processing an electronic exchange of goods and/or services. The client computing systems 520 and/or 522 may be associated with a specific goods purchasing activity, such as purchasing a vehicle, transferring title of real estate may perform communicate with one or more other platforms within the client computing system 520. In some cases, the client computing systems 520 and/or 522 may integrate API calls to request data, initiate functionality, or otherwise communicate with the one or more application computing systems 508, such as via the services. For example, the services may be configured to facilitate data communications (e.g., data gathering functions, data writing functions, and the like) between the client computing systems 520 and/or 522 and the one or more application systems 508.

The user device(s) 510 may be computing devices (e.g., desktop computers, laptop computers) or mobile computing device (e.g., smartphones, tablets) connected to the network 525. The user device(s) 510 may be configured to enable the user to access the various functionalities provided by the devices, applications, and/or systems in the network 525.

The database(s) 516 may comprise one or more computer-readable memories storing information that may be used and/or monitored by the data access monitoring and security system 504. For example, the database(s) 516 may store data utilized by one or more of the application computing systems that may include private or otherwise secure, non-public information. Additionally, the database(s) may store rule sets for evaluating data access events, identified activity patterns associated with permitted data access events, patterns of data access events associated with suspect activities, user group information, user information, application information, and/or the like. In an arrangement, the database(s) 516 may be used for other purposes as described herein. In some cases, the client computing system 520 and/or 522 may write data or read data to the database(s) 516 via the services. Operation of the distributed ledger computing system 532 and/or the centralized ledger computing system 524 may operate according to aspects described above with respect to FIGS. 1-4.

In one or more arrangements, the data access monitoring and security system 504, the application computing systems 508, the client computing system 522, the client computing system 520, the user devices 510, the centralized ledger computing system 524, the distributed ledger computing system 532 and/or the other devices/systems in the computing environment 500 may be any type of computing device capable of receiving input via a user interface, and communicating the received input to one or more other computing devices in the computing environment 500. For example, the data access monitoring and security system 504, the application computing systems 508, the client computing system 522, the client computing system 520, the user devices 510, the centralized ledger computing system 524, the distributed ledger computing system 532, and/or the other devices/systems in the computing environment 500 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the data access monitoring and security system 504, the application computing systems 508, the client computing system 522, the client computing system 520, the user devices 510, the centralized ledger computing system 524, the distributed ledger computing system 532, and/or the other devices/systems in the computing environment 500 may, in some instances, be and/or comprise special-purpose computing devices configured to perform specific functions.

FIG. 5B shows an illustrative data access monitoring and security system 504 in accordance with one or more examples described herein. The data access monitoring and security system 504 may be a stand-alone device and/or may at least be partial integrated with the development computing system 504 may comprise one or more of host processor(s) 555, medium access control (MAC) processor(s) 560, physical layer (PHY) processor(s) 565, transmit/receive (TX/RX) module(s) 570, memory 550, and/or the like. One or more data buses may interconnect host processor(s) 555, MAC processor(s) 560, PHY processor(s) 565, and/or Tx/Rx module(s) 570, and/or memory 550. The data access monitoring and security system 504 may be implemented using one or more integrated circuits (ICs), software, or a combination thereof, configured to operate as discussed below. The host processor(s) 555, the MAC processor(s) 560, and the PHY processor(s) 565 may be implemented, at least partially, on a single IC or multiple ICs. The memory 550 may be any memory such as a random-access memory (RAM), a read-only memory (ROM), a flash memory, or any other electronically readable memory, or the like.

Messages transmitted from and received at devices in the computing environment 500 may be encoded in one or more MAC data units and/or PHY data units. The MAC processor(s) 560 and/or the PHY processor(s) 565 of the data access monitoring and security system 504 may be configured to generate data units, and process received data units, that conform to any suitable wired and/or wireless communication protocol. For example, the MAC processor(s) 560 may be configured to implement MAC layer functions, and the PHY processor(s) 565 may be configured to implement PHY layer functions corresponding to the communication protocol. The MAC processor(s) 560 may, for example, generate MAC data units (e.g., MAC protocol data units (MPDUs)), and forward the MAC data units to the PHY processor(s) 565. The PHY processor(s) 565 may, for example, generate PHY data units (e.g., PHY protocol data units (PPDUs)) based on the MAC data units. The generated PHY data units may be transmitted via the TX/RX module(s) 570 over the private network 525. Similarly, the PHY processor(s) 565 may receive PHY data units from the TX/RX module(s) 565, extract MAC data units encapsulated within the PHY data units, and forward the extracted MAC data units to the MAC processor(s). The MAC processor(s) 560 may then process the MAC data units as forwarded by the PHY processor(s) 565.

One or more processors (e.g., the host processor(s) 555, the MAC processor(s) 560, the PHY processor(s) 565, and/or the like) of the data access monitoring and security system 504 may be configured to execute machine readable instructions stored in memory 550. The memory 550 may comprise (i) one or more program modules/engines having instructions that when executed by the one or more processors cause the data access monitoring and security system 504 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the data access monitoring and security system 504 and/or by different computing devices that may form and/or otherwise make up the data access monitoring and security system 504. For example, the memory 550 may have, store, and/or comprise a monitoring engine 550-1, a pattern recognition engine 550-2, a smart contract execution engine 550-3, and/or the like. The monitoring engine 550-1 may have instructions that direct and/or cause the data access monitoring and security system 504 to perform one or more operations associated with monitoring data access events throughout an enterprise network and logging such events to a blockchain to form an immutable record of data access activities on the enterprise network, and the like. The pattern recognition engine 550-2 may have instructions that may cause the data access monitoring and security system 504 to analyze and process a series of data access events (historical and/or real-time) to identify whether data access activities may comprise recognizable patterns of activity, and the like. The smart contract execution engine 550-3 may have instructions that may cause the data access monitoring and security system 504 to perform one or more operations associated with facilitate execution of rule sets and/or other smart contract functionality associated with the monitored data access events, where the rule sets may be associated with a particular user, a user group, and application and/or the like and if a pattern of suspect of activity, the smart contract may include functions that trigger mitigating events at one or more networked computing devices of the enterprise computing network, and the like.

While FIG. 5A illustrates the data access monitoring and security system 504 and/or the application computing systems 508, as being separate elements connected in the private network 525, in one or more other arrangements, functions of one or more of the above may be integrated in a single device/network of devices. For example, elements in the data access monitoring and security system 504 (e.g., host processor(s) 555, memory(s) 550, MAC processor(s) 560, PHY processor(s) 565, TX/RX module(s) 570, and/or one or more program/modules stored in memory(s) 550) may share hardware and software elements with and corresponding to, for example, the application computing systems 508.

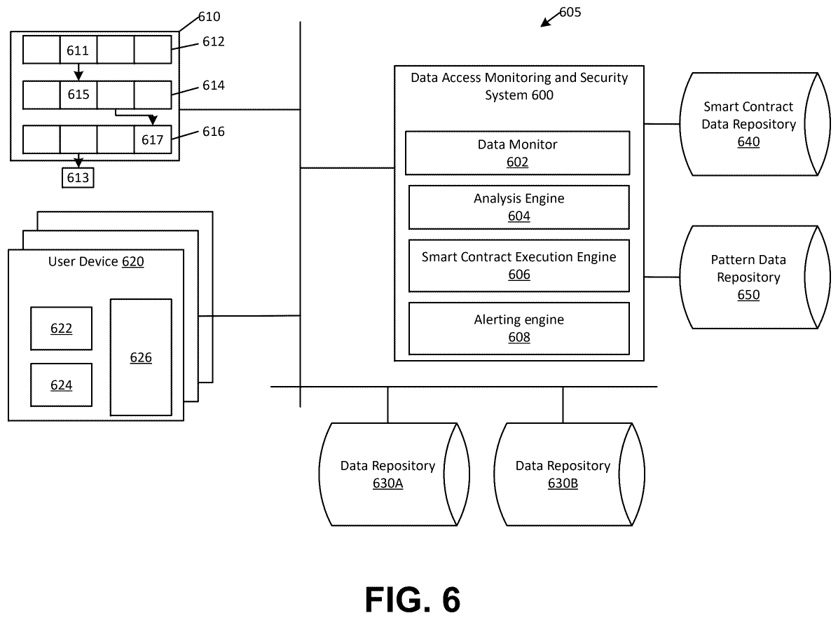

FIG. 6 shows an illustrative data access monitoring and security system 600 in accordance with one or more aspects described herein. The data access monitoring security system 600 may be associated with and/or utilize a distributed ledger computing system 610 comprising a plurality of blockchains (e.g., a blockchain 612, a blockchain 614, and a blockchain 616), a plurality of user devices (e.g., a computing device 620) associated with an enterprise computing system 605, where applications (e.g., the application 622) may access data (e.g., read, write, and the like) stored in data repositories (e.g., the data repository 630A, the data repository 630B, and the like) via a communication interface 626, wherein a data monitor 624 may be installed locally on one or more of the user computing devices to monitor data access activities performed by applications running on the local device. The data monitor 624 may communicate the data access event information to the data access monitoring and security system 600 for further analysis. The data access monitoring and security system 600 may further include a data monitor 602, an analysis engine 604, and a smart contract execution engine 606. In some cases, the data access monitoring and security system 600 may further include an alerting engine 608 that may trigger or otherwise send alerts to users and/or initiate corrective actions to remediate issues identified corresponding to suspected improper data use events. The data access monitoring and security system 600 may further include one or more data repositories, such as a pattern data repository 650 storing data access patterns that have been identified for individual user accounts, data access patterns indicative of suspicious or known malicious activities, and/or the like. In some cases, the data repositories may further include a smart contract data repository 640 that may store smart contract information that may be associated with user accounts, along with rule sets where instances of the smart contracts and/or rule sets may be included in particular blocks in the blockchains in the distributed ledger 610 upon creation of each block.

The distributed ledger system 610, comprises a plurality of blockchains, where each blockchain of the plurality of blockchain corresponds to a different user account. For example, the blockchain 612 comprises an ordered and linked series of blocks storing information corresponding to a series data access events performed by a first user account (e.g., a first user), blockchain 614 comprises an ordered and linked series of blocks storing information corresponding to a series data access events performed by a second user account (e.g., a second user), and the blockchain 616 comprises an ordered and linked series of blocks storing information corresponding to a series data access events performed by a third user account (e.g., an automated bot user account). Each block of the blockchain stores information corresponding to a data access event, where arrows between blocks represent data transfer event linking data access events between user accounts. For example, the data access event of the block 611 of the blockchain 612 may correspond to a data copy event by user 1, where the data is sent to user 2 via a second data access event (e.g., a data storage event caused at receipt of data sent from user 1, such as via an email) at the block 615 of the blockchain 614. In some cases, a user (e.g., the user (e.g., user 3) associated with the data access activities of the blockchain 616 may access data and send the data outside the enterprise network 605, as shown at 613, where the associated data access event may include communicating a message to a third party via email, sending the data via a communication network to an external computing system, sending the data to a printer to generate a hard copy of the data, sending the data to a removable media device, and/or the like.

Technology and data use is ubiquitous in today's society. As such, malicious actors may continually attempt to copy and/or otherwise access private or sensitive information, such as personal identification numbers and credit card numbers, which is a risk to both individuals and enterprise organizations. While numerous tools exist, but no single robust tool is available that is capable of performing real time detection.

As a solution, an integrated blockchain can facilitate all actions for memorializing data copying, viewing, and/or other data access activities. Data access may be legitimate or may include suspicious behavior, which may be detected using some machine learning algorithms to identify unauthorized copying and/or accessing data. For example, an extraction of the sensitive information may be automatically highlighted and the permissions for data access may be removed and all permissions may be revoked or removed, such as via use of smart contracts. For the systems and methods discussed in the present disclosure may integrate blockchain technology using artificial intelligence algorithms so that data access activities (e.g., copying, viewing, sending, and/or the like) may be monitored in real-time such as by a data access activity monitor.

The AI algorithms may identify these actions in real time and/or detect abnormal behaviors so that unauthorized copying of sensitive data, then automatically trigger an alert and/or automatically take corrective action to prevent future unauthorized access. An illustrative example of the proposed system may include four components. A first component is a blockchain ledger operating in a distributed ledger environment. Here, when an individual accesses data on the monitored system, each data access action (e.g., viewing, copying, copy to a clipboard, sending information in a message, and the like) may be captured into a block in a blockchain.

Once captured in the blockchain, these actions form an immutable record and cryptographically stored using hashing technologies in blocks in the blockchain. Further, because each block is linked to the next, a complete temporal record of data access is available for further analysis. As such, each data access activity is captured with a time of access, a method of access, an activity, data owner information, an account associated with accessing data, and/or the like. Additionally, all associated metadata may be stored in the blockchain ledger. This ledger may be analyzed further to identify patterns of data access, such as patterns indicating normal or expected access by the data owner or other authorized users. For example, an individual may typically access certain information daily as part of their job and/or may access particular amounts of data based on a particular activity normally performed. Any deviation from these learned patterns may be indicative of suspect activities, such as a user account unexpectedly copying terabytes of data during hours not normally worked.

The unauthorized copying monitoring and detection system may also analyze historical data use by users of an enterprise network. For example, the system may identify whether the user previously copied sensitive information and whether those activities corresponded to the user's former and/or current role within the organization. All data access activities across the enterprise network may be monitored by the unauthorized copying monitoring and detection system, such as by an artificial intelligence-based activity monitor using machine learning algorithms. Additionally, the unauthorized copying monitoring and detection system may include a smart contract module. The smart contract module may identify rules associated with a user, a user group, a role within the enterprise organization, a type of data to be accessed, an amount of data to be accessed, a privacy level and/or a security level of at least a portion of the data, and/or the like. The smart contract module may further activate and/or otherwise trigger instantiations of particular smart contracts based on the identified rules. Further, the smart contract module may trigger alerts based on identified suspect attempts at accessing data or improper access of data.

In an example, an activity monitor may monitor data access activities and/or actions performed on data stored on the enterprise network (e.g., selected databases, all data repositories) such as data reads, data writes, block transfers, copy to clipboard, creating files, copying files, and/or the like. The activity monitor may log such activities for each user and/or program that accesses data on the network and forward information to a smart contract module. The smart contract module may analyze received data against a ruleset the comprises data access rules associated with a user, program, user group, job description, program requirements, and/or the like. The smart contract module may, based on results of the rules-based analysis, may determine whether each data access event meets the ruleset requirements or may comprise suspicious activity. The smart contract module may initiate further actions for suspected suspicious activities, such as initiating further analysis, identifying whether the activity is allowable based on job functions, triggering an alert, disabling access to data repositories associated with the activity, disabling a user account, disabling a user group, quarantining an application or program, disabling data access, disabling communications of data to a recipient outside the enterprise network, and/or the like. As such the smart contract module may work in real-time to prevent unauthorized data copying or other access.

In some cases, the smart contract module may utilize a data copying algorithm (e.g., a data access algorithm) that may perform pattern matching using one or more models, such as a natural language processing (NLP) model. These models may be used to identify activities performed by the user, identify data accessed by the user, identify patterns of data access performed by the user, and/or the like. For example, an NLP model may analyze data to determine whether the data accessed comprises a format matching sensitive data. For example, a personal identification number issued by a governmental agency may be stored in a particular format and/or may have an associated maximum number of alphanumeric or numeric characters. In some cases, the NLP model may identify whether the data matches other sensitive data, such as account numbers, invoice number, dates of birth, and the like. These models may flag any identified patterns to trigger further analysis to determine whether the pattern is expected based on normal user activities, whether the pattern matches previously identified suspicious activity patterns, whether the activity pattern matches a known malicious activity pattern, and/or the like. If a malicious or suspicious activity pattern is identified (including a pattern that may be normal for a user having different permissions), an alert may automatically be triggered.

The unauthorized copying monitoring and detection system may utilize post incident analysis along with additional algorithms (e.g., AI algorithms) to flag and prevent unauthorized access or copying in real time reduce the risk of data breaches. In doing so, the unauthorized copying monitoring and detection system provides traceability and accountability by a smart contract-enabled blockchain system that can provide an immutable and transparent detailed audit trail of all data access within an enterprise network. Each user and/or application that accesses data within the network may be assigned a data access record blockchain stored in the blockchain ledger. Based on these different blockchains, unique data access patterns (e.g., a temporal data access pattern) may be identified for each user and/or application. In some cases, data transfer events between users and/or applications may cause links to be generated between different blockchains to enhance identification of data movement patterns throughout the enterprise network. As such, the unauthorized copying monitoring and detection system may detect and/or identify modern threat factors that may be evidence of activities attempting a security breach of the enterprise network, such as sophisticated insider threats, and the like that may be increasingly common, but difficult to identify. Each block in the blockchain may represent a different data access event, where metadata associated with the block corresponds to user information, application information, time and/or date information, activity information, and the like. While the blockchains discussed above may be associated to particular users and/or applications that access data, in some cases, data elements (e.g., a data repository, sensitive data elements, and the like) may further have an associated blockchain logging access and/or uses of that data to further enhance traceability of data use throughout the enterprise network.

In an illustrative example, the unauthorized copying monitoring and detection system may review current data access activities along with historical data access activities (e.g., 90 days of activities) to determine a number of user actions normally performed. Here, the unauthorized copying monitoring and detection system may also analyze additional information, such as the user's role, the activities normally performed, data access activities common to other individuals with a same or similar role, and the like. As such, the unauthorized copying monitoring and detection system may identify whether the user is performing data access activities as would be expected and/or whether any activities appear anomalous. In doing so, the unauthorized copying monitoring and detection system identifies patterns of activities that may further be compared (e.g., via one or more pattern analysis models) against data patterns normally performed or patterns found to be associated with suspicious activities. In some cases, private or sensitive data (e.g., identification numbers, account numbers, credit card numbers, addresses, phone numbers, and/or the like) may subject additional pattern matching and/or use analysis.

Additionally, the unauthorized copying monitoring and detection system may further analyze patterns to perform inactivity detection. Suppose a user has been inactive for a period of time, and suddenly an associated account is performing actions, such as copying data. In some cases, such activities that may be less suspicious under normal conditions may trigger additional analysis by the unauthorized copying monitoring and detection system after a threshold of inactivity condition has been met (e.g., 10 days, 20 days, one month, and the like). In some cases, accessing sensitive data, after this identified inactivity period, may trigger automated response even if the user's role and/or activity patterns show access to similar sensitive data. For example, if a user copies sensitive data to an application (e.g., a spreadsheet normally as part of their role adjacent activities, the same action following an extended absence may trigger further analysis (e.g., following a network account inadvertently left active following decommissioning of an application or a user leaving a position, and the like).

In some cases, the smart contract module may identify user network login and log out activities, which may further be analyzed via the rules and logged in the associated blockchain. In some cases, anomalous network login/log out activities may trigger additional scrutiny for user actions, particularly if a dynamic rule associated with a pattern of login activities associated with a user identifies an anomalous activity, such that any data access activities (e.g., reading data, writing data, copying data, sending data, and the like) may be compared to a different rule set (e.g., from a role-based rule set to an intruder-based rule set). Any triggers following such a rule set change may automatically trigger an alert being sent to appropriate individuals and/or initiate a quarantine of that user from being able to send data to external locations (e.g., to an external via a network, to an email recipient outside a department or the organization, copying data to a removable media device, and/or the like).

In some cases, a rule set associated with identifying improper and/or fraudulent activities may include rules such as limiting an ability to copy data (or a maximum amount of data) to a clipboard, limiting an ability to email data to identified addresses and/or domains, and the like. Such rules may be associated and/or customized based on a user role, a user department, a user group and/or the like. In some cases, rule sets may be enterprise wide, department or division wide, and/or the like. For example, users associated with a human resource department may have different rules for sensitive data access than users that are part of a user group associated with account management. For example, an HR user group member may normally work with sensitive data on an individual bases, while account management group may be accessing sensitive data for a group of account holders. As such, access to a block of account data may face additional scrutiny if performed by an HR user group member as opposed to a similar data access event from the account management user group member.

The unauthorized copying monitoring and detection system may monitor and/or pass metadata associated with data access events in real time to log the access event information in the blockchain ledger. In some cases, a block entry event may trigger analysis by an analysis engine. In some cases, a first pass analysis may be performed to identify whether data access activities match a normal activity pattern and, if not, additional analysis may be triggered. For example, a particular user account may typically perform a limited number of sensitive data access events within a particular time period (e.g., two data records daily), where other user accounts may normally perform a greater number (e.g., 10-20 data access events in an hour). If one or both users are suddenly accessing larger amounts of data (e.g., a data block of 5000 data records), the unauthorized copying monitoring and detection system may flag such an event as being unusual, trigger additional analysis, trigger an alert, lock down a particular user account, lock down the network, and/or the like. In some cases additional metadata (e.g., a time of day, a network device used, and the like) may further be considered by the unauthorized copying monitoring and detection system to dynamically modify analysis and/or remedial actions performed in real-time.

In some cases, the smart contract engine or module may process particular smart contracts based on the data activities and/or data access patterns identified. For example, a smart contact may be triggered, based on a particular access pattern, and immediately revoke a user account's data export permissions, block external device access to the database, automatically encrypt any sensitive data to prevent further access, and/or other actions. In some cases, particular smart contracts may process rules corresponding to user groups and/or organizations (e.g., external authorities), based on an identified risk corresponding to the monitored data access events.

In some cases, analysis performed by the unauthorized copying monitoring and detection system may identify gaps in the policies and/or rule sets associated with the policies. For example, the unauthorized copying monitoring and detection system may determine that the system is performing additional data use actions that may not be properly logged in the blockchain (e.g., printing or otherwise creating a physical copy of information such as after a prolonged display of sensitive data on a monitor). As such, the models may perform self-learning activities and/or other continuous learning functions to modify patterns and/or rule sets based on feedback from actions and/or alerts performed based on data access events identified and logged in the system. In some cases, any alert or other response to suspicious data access events may trigger creation, by the unauthorized copying monitoring and detection system, of a new block entry in one or more appropriate blockchains corresponding to the suspect data access event. In some cases, the blockchain may store a size of a data structure, file or other data block, in an associated block of the blockchain, where size and/or an associated checksum of the data may be monitored to identify whether and/or when a change event occurred.

In some cases, the activity monitor of the unauthorized copying monitoring and detection system may trigger an appropriate smart contract associated with a data user event, such as a data exportation algorithm, where the smart contract may trigger the system to block the associated network account, in real time. As such, the unauthorized copying monitoring and detection system may include real-time data security functionality to monitor data access events, manage user access rights based on data access events and/or identified data access event patterns, proactively control access and/or rights to network access to one or more user groups based on an identified severity and/or risk of identified data security events. In some cases, the unauthorized copying monitoring and detection system may monitor both network-based events (e.g., copying blocks of data between data storage locations) and local device events (e.g., displaying sensitive data on a monitor for an extended time and/or printing data outside of normal activity patterns). For example, the unauthorized copying monitoring and detection system may generate blocks in a block chain when a user triggers, via a keyboard shortcut or mouse-click event, a copy data access event, a paste event, a print-screen event, a screenshot event, and/or the like.

In an illustrative example, the unauthorized copying monitoring and detection system may utilize the activity monitor to identify a screenshot event. Once detected, the activity monitor may utilize and/or trigger analysis by one or more machine learning models to analyze information associated with the data access event. Here, the activity monitor may perform actions on screenshot to identify information included in the screenshot image and an associated sensitivity of that identified data. For example, a natural language processing engine may process text identified in the image to determine whether sensitive date (e.g., account numbers, identification numbers, and/or the like) are included in the image, whether the image was saved, sent via a message to a recipient, printed, and/or the like. Each event, and the associated data and metadata is stored in corresponding blocks in a blockchain, and/or linked between related blockchains associated with different users and/or accounts (e.g., an automated account associated with an application) that are associated with a data transfer event.

In some cases, the unauthorized copying monitoring and detection system may be a centralized analysis system. In other cases, the unauthorized copying monitoring and detection system may be a distributed, or partially distributed, system where local devices and/or application computing systems may have local instances of at least a portion of the unauthorized copying monitoring and detection system. For example, local computing devices and/or application computing system may include a local monitoring engine that may update a centralized unauthorized copying monitoring and detection system. In such cases, an intelligent monitoring engine may process an algorithm in the background of the local devices monitoring local data access events on the local device, to the local device and/or from the local device.

In some cases, operation of the copying monitoring and detection system may begin with input and/or initialization activities. For example, the unauthorized copying monitoring and detection system may register sensitive data and/or identify systems that utilize sensitive data. Further, the unauthorized copying monitoring and detection system may generate a hash of each customer records and register each customer record in the distributed ledger, where each user account may be associated with a unique blockchain. In some cases, each sensitive data record may further be assigned a unique blockchain. Metadata associated with each blockchain (e.g., in a root block) may include file identifiers, authorized access users, access policies (e.g., “No copying allowed to external devices”), user authentication information, and the like. Each user may log in using their credentials, which may be authenticated via multi-factor authentication). This access attempt is then recorded immutably in a block on the blockchain.

The copying monitoring and detection system may further perform real-time monitoring and detection of data access events. In an illustrative example of a user access attempt, a user may open or otherwise access a database and access stored data (e.g., customer data that may include sensitive or non-public information). The copying monitoring and detection system monitors this action and passes metadata to the AI engine for analysis. The copying monitoring and detection system may further perform AI-based behavior analysis and/or profile generation. For example, a baseline behavior may be identified, such as that a user may typically accesses 10-20 records daily for their role. However, a current behavior may be identified in real time where the user suddenly requests access to thousands of records and tries to export them. The copying monitoring and detection system flags this as anomalous based on one or more factors and/or rules, such as by identifying an unusual data volume, an unusual time of access (e.g., after business hours), an unusual device usage (e.g., an external USB was detected), and the like. The copying monitoring and detection system may further include a dynamic response mechanism that flag risk, such as by flagging the above-described anomalous behavior as being high-risk, where the copying monitoring and detection system also may automatically generate an alert.

The copying monitoring and detection system may also utilize one or more smart contract triggers. A smart contract instance may be stored in the blockchain and/or linked from a block in the block chain that may enforce one or more data access and/or data utilization rules. These rules may cause immediate revocation of the user's data export permissions, blocking of external device access to the user computing device and/or to database, encryption of the sensitive data to prevent further access, and/or the like. Additionally, the copying monitoring and detection system may further provide alerts to one or more users of the enterprise network, such as to an administrator. For example, the copying monitoring and detection system may generate an alert to one or more security teams to notify one or more team members in in real-time with details of the user (e.g., name, department, IP address), one or more actions in an action chain taken by that user (e.g., data encryption, USB device), and the like.

The copying monitoring and detection system may further be configured to perform audits of data usage and/or forensic analysis of historical information relating to data usage, such as by analyzing immutable data logs. For example, each blockchain logs every step of a particular user's data access attempts (and/or every access attempt for each data record storing sensitive or private information) including the user's data access request, an anomaly detection and risk score flagged by AI, and preventive actions triggered by the smart contract. The copying monitoring and detection system may further perform post-incident forensics including AI-based analysis of each suspicious data access incident to identify a root cause of the data access incident, such as where a user attempted to copy data without proper authorization. Further the post-incident forensics may also analyze associated risks, such as whether the user may have been using a compromised device.

The copying monitoring and detection system may utilize continuous learning and/or policy adaptation algorithms, such as where an AI-based module automatically refines its behavioral models, such as by updating risk parameters for data access outside business hours and incorporating patterns from this incident to detect similar attempts in the future. The blockchain policy updates may be performed automatically by the copying monitoring and detection system where access policies stored on the blockchain are updated, such as by defining stricter rules for large-volume data exports and/or mandating additional approvals for off-hours data access.

Output of the copying monitoring and detection system may include, such as for a scenario of a detected anomaly, may include:
AI Detection: Anomaly detected for user User123
ACTION: Blocking user access and alerting administrator...
Blockchain Log:
   Block Data: Genesis Block
   Previous Hash: 0
   Current Hash: b8f . . .
   - - -
   Block Data: Access by User123, Data Size: 1200, Time: after Hours
   Previous Hash: b8f . . .
   Current Hash: a2d . . .
   - - -
   Block Data: Action: User access blocked for User123
   Previous Hash: a2d . . .
   Current Hash: c43 . . .

Output associated with an event where no anomaly was detected may include:
Rule—If data_Size=500 and access_Time=“business_Hours”, the output would be:
AI Detection: No anomaly detected for user User123
ACTION: Access allowed for user User123
Blockchain Log:
   Block Data: Genesis Block
   Previous Hash: 0
   Current Hash: b8f . . .
   - - -
   Block Data: Access by User123, Data_Size: 500, Time: business_Hours
   Previous Hash: b8f . . .
   Current Hash: a1c . . .

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system comprising:
a distributed ledger computing system comprising a plurality of blockchains, wherein each block of each blockchain of the plurality of blockchains comprise information corresponding to a data access event on an enterprise network;
a computing platform, comprising:
at least one processor; and
memory storing computer-readable instructions that, when executed by the at least one processor, cause the computing platform to:
monitor, by a monitoring engine, a plurality of data access events of data stored on the enterprise network;
log, by the monitoring engine, information corresponding to each data access event of the plurality of data access events with an associated blockchain of the plurality of blockchains, wherein a new block is added to the associated blockchain for each logged data access event;
identify, by an analysis engine, based on data access event information corresponding to each logged data access event and historical data access event information, an activity pattern corresponding to each logged data access event;
determine, by the analysis engine, whether the activity pattern matches a pattern of suspect activity; and
initiate, based on data access event information and activity pattern information, operation of a smart contract, wherein the smart contract causes performance of a first enterprise network action in response when the activity pattern matches the pattern of suspect activity.

2. The system of claim 1, wherein the plurality of blockchains of the distributed ledger computing system comprises a first portion of blockchains where each blockchain of the first portion of blockchains corresponds to a different network account associated with the enterprise network.

3. The system of claim 1, wherein the plurality of blockchains of the distributed ledger computing system comprises a second portion of blockchains where each blockchain of the second portion of blockchains corresponds to a different data record stored in a data repository associated with the enterprise network.

4. The system of claim 3, wherein each of different data record corresponding to a particular blockchain of the second portion of blockchains comprises non-public or otherwise private information.

5. The system of claim 1, wherein the monitoring engine comprises a centralized computing platform.

6. The system of claim 1, wherein the monitoring engine comprises a distributed monitoring computing platform, wherein each computing device of the enterprise network comprises a local monitoring engine.

7. The system of claim 1, wherein the monitoring engine identifies metadata associated with each data access event and wherein the metadata is recorded in the new block of an associated data access event.

8. The system of claim 7, wherein the metadata comprises one or more of user information, user account information, computing device information, access time and/or date information, and data access event type information.

9. The system of claim 1, wherein the system further comprises a data repository storing a plurality of data access patterns, wherein each of the data access patterns comprises one of a pattern of activity identified on the enterprise network, a pattern of activity corresponding to a user role, or a pattern of activity corresponding to data use indicative of a suspect activity.

10. The system of claim 1, wherein the pattern of suspect activity is indicative of malicious use of private information stored in a data repository of the enterprise network.

11. The system of claim 1, wherein the first enterprise network action comprises sending an alert message to a user device, wherein the alert message comprises data access event information and information corresponding the match between the activity pattern and the pattern of suspect activity.

12. The system of claim 1, wherein the first enterprise network action comprises automatically disabling a user account associated with the data access event.

13. The system of claim 1, wherein the first enterprise network action comprises automatically disabling data access within the enterprise network.

14. Nontransitory computer readable media storing instructions that, when executed by a processor, cause a computing platform to:
monitor, by a monitoring engine, a plurality of data access events of data stored on an enterprise network;
log, by the monitoring engine, information corresponding to each data access event of the plurality of data access events with an associated blockchain of a plurality of blockchains of a distributed ledger computing system, wherein a new block is added to the associated blockchain for each logged data access event;
identify, by an analysis engine, based on data access event information corresponding to each logged data access event and historical data access event information, an activity pattern corresponding to each logged data access event;
determine, by the analysis engine, whether the activity pattern matches a pattern of suspect activity; and
initiate, based on data access event information and activity pattern information, operation of a smart contract, wherein the smart contract causes performance of a first enterprise network action in response when the activity pattern matches the pattern of suspect activity.

15. The nontransitory computer readable media of claim 14, wherein the plurality of blockchains of the distributed ledger computing system comprises a first portion of blockchains where each blockchain of the first portion of blockchains corresponds to a different network account associated with the enterprise network.

16. The nontransitory computer readable media of claim 14, wherein the plurality of blockchains of the distributed ledger computing system comprises a second portion of blockchains where each blockchain of the second portion of blockchains corresponds to a different data record stored in a data repository associated with the enterprise network.

17. The nontransitory computer readable media of claim 16, wherein each of the different data records corresponding to a particular blockchain of the second portion of blockchains comprises non-public or otherwise private information.

18. The nontransitory computer readable media of claim 14, wherein the monitoring engine comprises a centralized computing platform.

19. The nontransitory computer readable media of claim 14, wherein the monitoring engine comprises a distributed monitoring computing platform, wherein each computing device of the enterprise network comprises a local monitoring engine.

20. The nontransitory computer readable media of claim 14, wherein the monitoring engine identifies metadata associated with each data access event and wherein the metadata is recorded in the new block of an associated data access event.
